(19) United States
(12) Patent Application Publication
(10) Pub. No.: US 2020/0216008 A1
(43) Pub. Date: Jul. 9, 2020

(54) AIRBAG MODULE HAVING LOW TOLERANCES

(71) Applicant: Autoliv Development AB, Vargarda (SE)

(72) Inventors: Michael BURGER, Karlsfeld (DE); Peter CHRISTOPH, Erdweg (DE); Remi BAILLIVET, Dampierre-en-Bray (FR)

(21) Appl. No.: 16/647,090

(22) PCT Filed: Sep. 11, 2018
(86) PCT No.: PCT/EP2018/074379

§ 371 Date: Mar. 13, 2020

(30) Foreign Application Priority Data
Sep. 13, 2017 (DE) 102017121148.9

(51) Int. Cl. B60R 21/203

(52) U.S. Cl. CPC B60R 21/2037; B60Q 5/003

(57) ABSTRACT

The present invention relates to an airbag module (1), comprising a housing (2), a cover (3) connected to the housing (2) for forming a receiving space, a gas generator (4) arranged in the receiving space, an airbag arranged in the receiving space and a plate (5) for securing the airbag module (1) on a steering wheel, characterized in that the housing (2), the cover (3), the gas generator (4) and the airbag form an assembly, which is connected to the plate (5) via at least one releasable securing device (6), wherein at least the cover (3) of the assembly and the plate (5) can be moved relative to one another in a parallel direction (7) in relation to the plate (5) when the securing device (6) is partially released, and are secured relative to one another in a parallel direction (7) in relation to the plate (5) when the securing device (6) is tightened.

The present invention relates to an airbag module comprising a housing, a cover connected to the housing for forming a receiving space, a gas generator arranged in the receiving space, an airbag arranged in the receiving space and a plate for securing the airbag module on a steering wheel. The invention also relates to a method for producing such an airbag module.

It is required that at least the components of an airbag module visible to the occupant are arranged in a highly symmetrical manner in a steering wheel. For this purpose, it is necessary for a defined alignment between a steering wheel connection point of the airbag module and the external edges of the visible components of the airbag module to be maintained in parallel to a steering wheel rim plane. However, due to the tolerance chain of the connections between the steering wheel connection point and the visible parts of the airbag module, the required alignment is difficult to maintain.

GB 2 414 717 A therefore proposes that a fastening plate for an airbag module is pre-assembled on the steering wheel with the smallest tolerance. For this purpose, the fastening plate is first aligned relative to the steering wheel and only fixed in the aligned position by means of fastening elements. This procedure is particularly useful when the components of the airbag module visible to the occupant are attached directly to the fastening plate. If other components of the airbag module are fastened to the fastening plate, too great a deviation can nevertheless occur due to the tolerance chain present in the airbag module. In addition, the procedure is only expedient if the fastening plate can be pre-assembled on the steering wheel before the remaining components of the airbag module are assembled.

The object of the present invention is therefore to at least partially eliminate the disadvantages described with reference to the prior art and in particular to specify an airbag module and a method for producing an airbag module with which the alignment deviation in or parallel to the steering wheel plane between the steering wheel connection point of the airbag module and the edges of the parts of the airbag module visible to the occupant can be kept low.

The object is achieved by an airbag module and a method having the features of the respective independent claim. Advantageous developments of the airbag module and of the method are specified in the dependent claims and in the description, wherein individual features of the advantageous developments can be combined with one another as desired in a technically sensible manner.

The object is achieved in particular by an airbag module having the above-mentioned features, in which the housing, the cover, the gas generator and the airbag form an assembly which is connected to the plate by means of at least one, in particular common, releasable securing device, wherein at least the cover of the assembly and the plate can be moved relative to one another in a parallel direction in relation to the plate when the securing device is partially released and are fixed relative to one another in a parallel direction in relation to the plate when the securing device is tightened. In particular, the assembly also includes all further components of the airbag module arranged in the receiving space.

The object is also achieved by a method for producing an airbag module, comprising at least the following steps:
a) assembling an assembly comprising a housing, a cover, a gas generator and an airbag,
b) connecting the assembly to a plate by means of a securing device, wherein the securing device remains partially released,
c) measuring an alignment between the housing and the plate in at least one direction parallel to the plate,
d) comparing the measured alignment with a predetermined value in order to determine a deviation,
e) loading at least one element of the assembly with a force in a direction parallel to the plate in order to reduce the deviation,
f) tightening the securing device in order to fix at least the cover in a direction parallel to the plate in relation to the plate,
wherein step b) could be carried out as an intermediate step of step a).

The basic idea of the invention thus provides that at least the components visible to the occupant can still be aligned relative to the plate to be secured on the steering wheel, for example, in the order of magnitude of one millimeter or less, before the securing device is finally tightened, wherein, by tightening the securing device, the final fixing takes place in parallel to the plate and thus in parallel to the steering wheel plane. For this purpose, one element of the assembly, in particular the housing, has a recess, through which the securing device engages, wherein the recess has a diameter which is the greater than the outside diameter of the securing device. By introducing a force having a component parallel to the plate, the tolerances between the individual components of the assembly can be at least partially compensated. The components visible to the occupant are therefore arranged after assembly on the steering wheel with high symmetry.

“Parallel direction to the plate” means that movement can be carried out in a plane substantially parallel to the plate. In particular, a relative movement can take place in at least two preferably mutually orthogonal directions parallel to the plate.

For a simple production process, it is preferred that the at least one releasable securing device can be actuated from the side of the airbag module facing away from and opposite the cover.

The plate can be embodied, for example, as a horn plate having at least one horn contact, wherein preferably at least one elastic element, for example at least one spring, is arranged between the horn plate and the assembly. In order to trigger the horn function, the assembly would therefore be moved axially toward the horn plate. The horn plate would thus be secured directly on the steering wheel. In this context, it is preferred if the tightened securing device can be moved together with the assembly relative to the horn plate when the horn function is triggered. However, the horn contact can also be embodied as a piezo element, which detects a pressure exerted on the assembly and thereupon triggers the horn signal. In this case, the assembly is not necessarily movable onto the horn plate.

Alternatively, the plate may be a securing plate that prevents detachment of the cover from the housing. In such an embodiment, hook elements preferably formed on the cover and resiliently deflectable engage through openings in the housing, wherein the securing plate can be arranged after mounting of the cover on the housing in such a way that re-deflection of the hook elements is prevented by the securing plate, whereby the cover is secured on the housing.

For exact alignment of the airbag module on the steering wheel in or parallel to the steering wheel plane, at least one fixing element projects from the plate in the direction of the steering wheel, with which fixing element the airbag module can be positively fixed to the steering wheel in a parallel direction in relation to the plate. The fixing element can be formed integrally with the plate, but it is also possible for the fixing element to be rigidly connected to the plate as an independent component. The at least one fixing element thus forms the above-mentioned steering wheel connection point of the airbag module.

In one embodiment, the securing device can comprise a shoulder nut and a threaded pin engaging in the shoulder nut, wherein the shoulder nut is accessible, in particular, from the side facing away from and opposite the cover, and the threaded pin is connected non-rotatably to an element of the assembly. The threaded pin is preferably connected to an element of the airbag module arranged in the receiving space, for example to the gas generator or to a diffuser at least partially overlapping the gas generator. By tightening the securing device, the element of the assembly penetrated by the securing device, for example, is clamped between the element connected non-rotatably to the threaded pin and an end face of the shoulder nut facing the assembly and thus fixed in a parallel direction in relation to the plate. For this purpose, the shoulder nut can be rotatably mounted in the plate, but the shoulder nut is positively arranged in the plane of the plate in this case.

The securing device preferably penetrates through a recess in one element of the assembly, wherein an outside diameter of the securing device in the region of the passage is smaller than a diameter of the recess. In this case, it is provided in particular that the recess is formed in the housing connected to the cover and at least one component of the securing device is rigidly connected to an element of the airbag arranged in the housing, wherein the housing is movable relative to the element of the airbag module when the securing device is partially released and is fixed when the securing device is tightened. This can be achieved in particular in that a diffuser arranged in the receiving space is coupled to the securing device.

The invention and the technical environment are explained by way of example below with reference to the figures. These show schematically

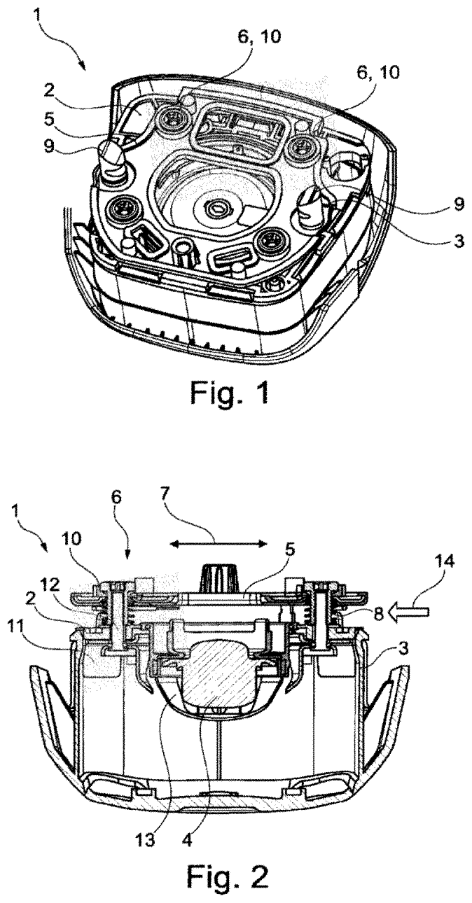

FIG. 1: a perspective view of the rear side of an airbag module; and

FIG. 2: a sectional view through the airbag module.

The airbag module 1 shown in the figures comprises a housing 2, a cover 3 connected to the housing 2, a gas generator 4 and an airbag, not shown, being arranged in the receiving space formed by the housing 2 and the cover 3. The gas generator 4 is additionally covered on one side by a diffuser 13.

The airbag module 1 further comprises a plate 5 designed as a horn plate, from which fixing elements 9 project. The airbag module 1 can be secured on a steering wheel with the fixing elements 9. Springs 9 are arranged between the plate 5 and the housing 2 and are compressed when the horn function is triggered.

Furthermore, a securing device 6 is formed which connects the plate 5 to the other components of the airbag module 1. The securing device 6 comprises a shoulder nut 10 which is arranged rotatably in the plate 5 positively in its radial direction and movably in its axial direction. The securing device 6 furthermore comprises a threaded pin 11 which is non-rotatably connected to the diffuser 13. The threaded pin 11 is guided through a recess 12 in the housing 2, the diameter of the recess 12 being larger than the outside diameter of the threaded pin 11.

When the securing device 6 is not yet fully tightened, the housing 2 and thus also the cover 3 can be moved relative to the threaded pin 11, to the diffuser rigidly connected to the threaded pin 11 and thus in a parallel direction 7 in relation to the plate 5. After the securing device 6 has been tightened completely, the housing 2 is fixed between the end face of the shoulder nut 10 and the diffuser 13. When the horn function is triggered, the securing device 6 is moved together with the housing 2 relative to the plate 5.

It is thus possible for an alignment of the cover 3 in relation to the plate 5 in the parallel direction 7, which can also extend into the plane of the drawing, to be measured before the tightening. This measured alignment can be compared with a predetermined value and the deviation can be minimized by introducing a force 14.

### LIST OF REFERENCE SYMBOLS

1 Airbag module
2 Housing
3 Cover
4 Gas generator
5 Plate
6 Securing device
7 Parallel direction
8 Spring
9 Fixing element
10 Shoulder nut
11 Threaded pin
12 Recess
13 Diffuser
14 Force

1. Airbag module, comprising a housing, a cover connected to the housing for forming a receiving space, a gas generator arranged in the receiving space, an airbag arranged in the receiving space and a plate for securing the airbag module on a steering wheel, characterized in that the housing, the cover, the gas generator and the airbag form an assembly, which is connected to the plate via at least one releasable securing device, wherein at least the cover of the assembly and the plate can be moved relative to one another in a parallel direction in relation to the plate when the securing device is partially released, and are secured relative to one another in a parallel direction in relation to the plate when the securing device is tightened.

2. Airbag module according to claim 1, wherein the at least one releasable securing device is actuatable from the side facing away from and opposite the cover.

3. Airbag module according to claim 1, wherein the plate is a horn plate.

4. Airbag module according to claim 3, wherein the securing device is movable together with the assembly relative to the horn plate when the horn function is triggered.

5. Airbag module according to claim 1, wherein the plate is a securing plate preventing detachment of the cover from the housing.

6. Airbag module according to claim 1, wherein at least one fixing element projects from the plate in the direction of the steering wheel, with which fixing element the airbag module can be positively fixed to the steering wheel in a parallel direction in relation to the plate.

7. Airbag module according to claim 1, wherein the securing device comprises a shoulder nut and a threaded pin engaging in the shoulder nut.

8. Airbag module according to claim 7, wherein the shoulder nut is accessible from the side facing away from and opposite the cover and the threaded pin is non-rotatably connected to an element of the assembly.

9. Airbag module according to claim 1, wherein the securing device extends through a recess in one element of the assembly and an outside diameter of the securing device in the region of the passage is smaller than a diameter of the recess.

10. Airbag module according to claim 9, wherein the recess is formed in the housing connected to the cover and at least one component of the securing device is rigidly connected to an element of the airbag module arranged in the receiving space, wherein the housing is movable relative to the element of the airbag module when the securing device is partially released and is fixed when the securing device is tightened.

11. Method for producing an airbag module, comprising at least the following steps:
a) assembling an assembly comprising a housing, a cover, a gas generator and an airbag,
b) connecting the assembly to a plate by means of a securing device, wherein the securing device initially remains partially released,
c) measuring an alignment between the cover and the plate in at least one direction parallel to the plate,
d) comparing the measured alignment with a predetermined value in order to determine a deviation,
e) loading at least one element of the assembly with a force in a direction parallel to the plate in order to reduce the deviation,
f) tightening the securing device in order to fix at least the cover in a direction parallel to the plate in relation to the plate.
